(19) United States
(12) Patent Application Publication
(10) Pub. No.: US 2018/0060623 A1
(43) Pub. Date: Mar. 1, 2018

(54) SYSTEMS AND METHODS FOR CONSUMER PRODUCT ORGANIZATION AND PACKING

(71) Applicant: John B. Devine, JR., Ridgefield, CT (US)

(72) Inventor: John B. Devine, JR., Ridgefield, CT (US)

(21) Appl. No.: 15/690,514

(22) Filed: Aug. 30, 2017

Related U.S. Application Data
(60) Provisional application No. 62/381,630, filed on Aug. 31, 2016.

(51) Int. Cl. G06K 7/10; G06Q 10/08; B65D 25/04; B65D 25/30; B65D 21/02

(52) U.S. Cl. CPC G06K 7/10366; G06Q 10/087; B65D 21/0233; B65D 25/30; B65D 21/0209; B65D 25/04

(57) ABSTRACT

Systems, methods, and articles of manufacture provide for improved consumer product organization and packing.

### CROSS-REFERENCE TO RELATED APPLICATIONS

The present application claims benefit and priority to, and is a non-provisional of, U.S. Provisional Patent Application No. 62/381,630 filed Aug. 31, 2016 and titled “CONSUMER PRODUCT TOTE ORGANIZER”, the contents of which are hereby incorporated by reference in their entirety herein.

### BACKGROUND

The consumer product retail industry often involves the stocking and selling of thousands of different products that must be displayed in retail sales space and restocked upon (or prior to) depletion. Any particular retail store may, for example, stock approximately one hundred thousand (100,000) different products—e.g., identified by one hundred thousand (100,000) unique Stock Keeping Unit (SKU) identifiers. As inventory is sold or reduced, retail stores order replacement units of individual products (i.e., having individual SKU identifiers) from a warehouse. Each order that comes into a warehouse location from each of a multitude of retail store locations may identify a wide assortment of SKU identifiers and/or assortments of products. The ordered assortments do not necessarily adhere to any particular pattern either, as they depend upon the sales activity at each individual retail store location (e.g., in the previous week).

Each individual SKU identifier has a designated “pick” location in the warehouse. In the cosmetic category alone, any single warehouse location may stock in excess of ten thousand (10,000) different products having ten thousand (10,000) different associated SKU (and/or Universal Product Code (UPC)) identifiers and attendant ten thousand (10,000) different “pick” locations. Each “pick” location may, for example, contain a “master case” of a particular product (a particular SKU and/or UPC) obtained from the product's manufacturer and placed in the designated warehouse slot/“pick” location.

To process the orders received from retail locations, warehouse employees manually pick individual units of product from appropriate “pick” locations in the warehouse and add them to a bin or tote (a “master tote”) destined for a particular retail store location. On average, any given retail store location may receive one hundred (100) master totes from the warehouse. While the contents of any given master tote may be sorted by broad category (e.g., cosmetics, vitamins, analgesics), they generally contain a wide mix of product types, manufactures/brands, and prices of products.

Upon arrival at a retail store location, a retail store employee generally utilizes a rolling cart to move a master tote around the retail floor, where the employee manually sorts and finds each individual product's appropriate retail sales location. As the retail store stocks tens of thousands of individual products, many of which are restocked on a weekly basis, the amount of time that retail employees spend engaged in on-floor product sorting and restocking becomes significant. Time spent unloading master totes, sorting disorganized products within each master tote, locating retail display locations for each unit of product randomly selected from each master tote, and the time spent with bulky master totes and wheeled carts blocking retail shopping aisles and/or displays, each of which results in lost profits for the retail store location. These losses are compounded for larger retail chains that own and/or operate a plurality of retail store locations.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1A, FIG. 1B, and FIG. 1C are perspective diagrams of a prior art packing system;

FIG. 2A, FIG. 2B, FIG. 2C, FIG. 2D, FIG. 2E, FIG. 2F, and FIG. 2G are perspective, top, left, right, front, back, and bottom views of a consumer product organization and packing system according to some embodiments;

FIG. 3 is an assembly diagram of a consumer product organization and packing system according to some embodiments; and

FIG. 4 is a perspective diagram of a consumer product organization and packing system according to some embodiments.

### DETAILED DESCRIPTION

### I. Introduction

While lost profits due to restocking inefficiencies have long been realized in the retail sales industry, each type of retail sales location experiences unique challenges and differences that have hindered development of a universal solution to the problem. In the consumer health, wellness, and personal care retail environment, for example, most retail products are “small”. As utilized herein, the term “small” may refer to products that have a per-unit weight of less than or equal to one pound (1 lb.) and the term “medium” may refer to products that have a per-unit weight of greater than one pound (1 lb.) but less than three pounds (3 lbs.). In other retail sales types, such as home improvement or hardware, many products may weigh five pounds (5 lbs.) or more—e.g., a five pound (5 lb.) can of paint. In retail sales environments where the average product is small or medium, such as in the consumer health/wellness/personal care category, the size and type of master totes utilized is relatively standardized.

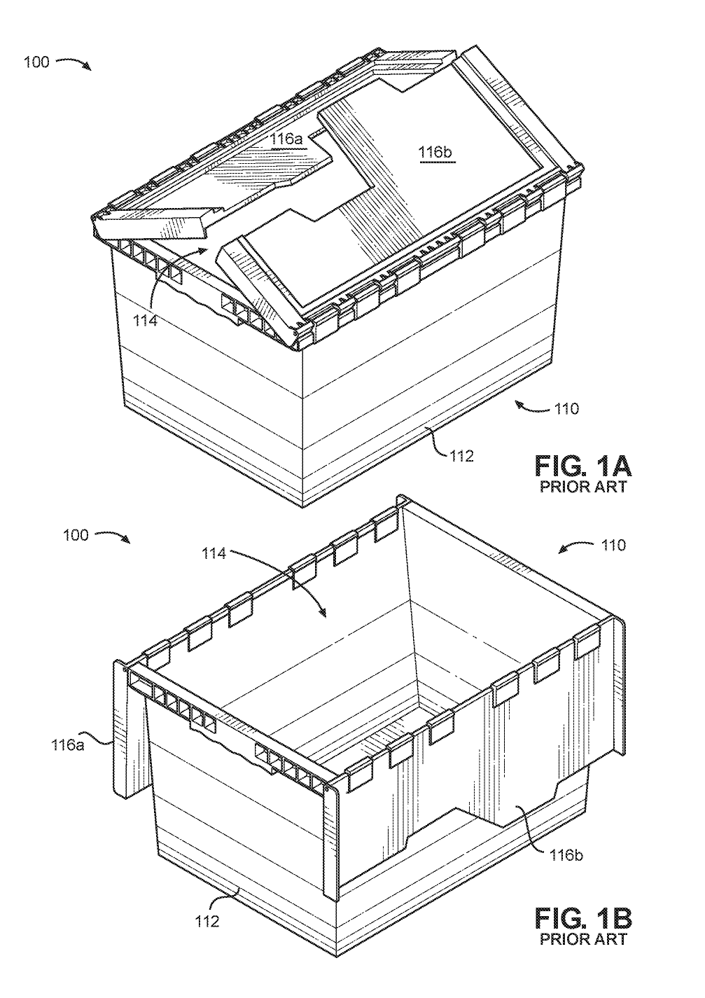

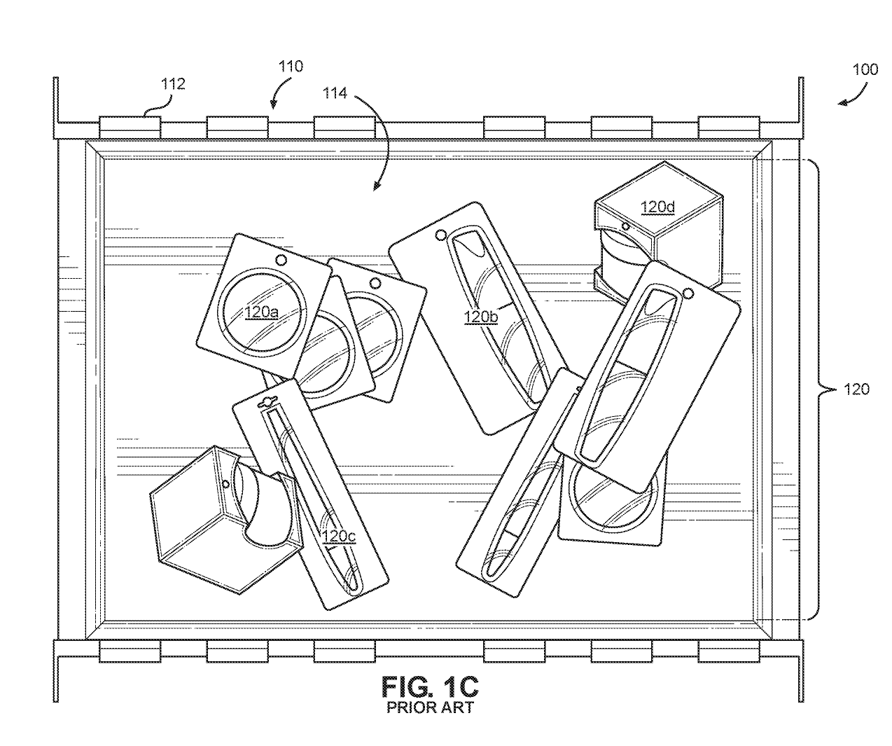

As depicted in FIG. 1A, FIG. 1B, and FIG. 1C, for example, perspective diagrams of a prior art retail consumer product packing system 100 are shown. The prior art retail consumer product packing system 100 may generally comprise a “master tote” 110. In some cases, the master tote 110 may comprise a rectangular bin body 112 defining a generally rectangular interior storage area 114. As depicted, the rectangular bin body 112 may be tapered such that a bottom width dimension is less than an upper width dimension, which facilitates nested stacking of empty master totes 110, e.g., in a warehouse location. In many cases, the master tote 110 may comprise a pair of opposing and interoperable lid portions 116a-b that are hingedly attached to opposing upper edges of the rectangular bin body 112, as depicted in a partially closed state in FIGS. 1A and 1n an open state in FIG. 1B.

In some cases, the prior art retail consumer product packing system 100 may be utilized to hold, contain, and/or transport a plurality of units of product 120. As depicted in FIG. 1C, for example, the plurality of units of product 120 may be randomly tossed into and/or disposed in the generally rectangular interior storage area 114 of the master tote 110, which is common practice. Accordingly, while each product 120 in the master tote 110 may belong to a particular category such as “cosmetics”, a first product 120a may comprise a cosmetic product such as mascara from a first manufacturer or brand, a second product 120b may comprise an eye pencil from a second manufacturer or brand, a third product 120c may comprise a pair of scissors from a third manufacturer or brand, and/or a fourth product 120e may comprise makeup from a fourth manufacturer or brand. As depicted, some products 120 may be located underneath under products 120 (partially or entirely) and a retail store employee must accordingly sift through the interior storage area 114 of the master tote 110 in an attempt to locate additional units of, for example, the first product 120a. Any products 120 that are missed by the employee while at the appropriate stocking location on the retail floor would require a repeat restocking visit to the same retail location at a different time.

The inefficiency of manual picking or sifting through the products 120 disposed randomly throughout the interior storage area 114 of the master tote 110 and the burden to the retail floor of increased restocking traffic and increased time required to take up space on the retail floor have remained problems that plague retails sales locations.

In accordance with embodiments herein, these and other deficiencies of previous efforts are remedied by providing systems, apparatus, methods, and articles of manufacture for improved consumer product organization and packing. In some embodiments, for example, a specially-designed and/or constructed master tote divider or caddy may be provided that allows for: (i) in-warehouse pre-sorting of small and/or medium products into different price, manufacture/brand, and/or sub-category groupings, (ii) easier in-warehouse and/or in-store transportation of products to be restocked, (iii) less disruption to retail sales floor area during restocking, and/or (iv) less retail employee time needed to restock large volumes of various categories of products.

### II. Systems

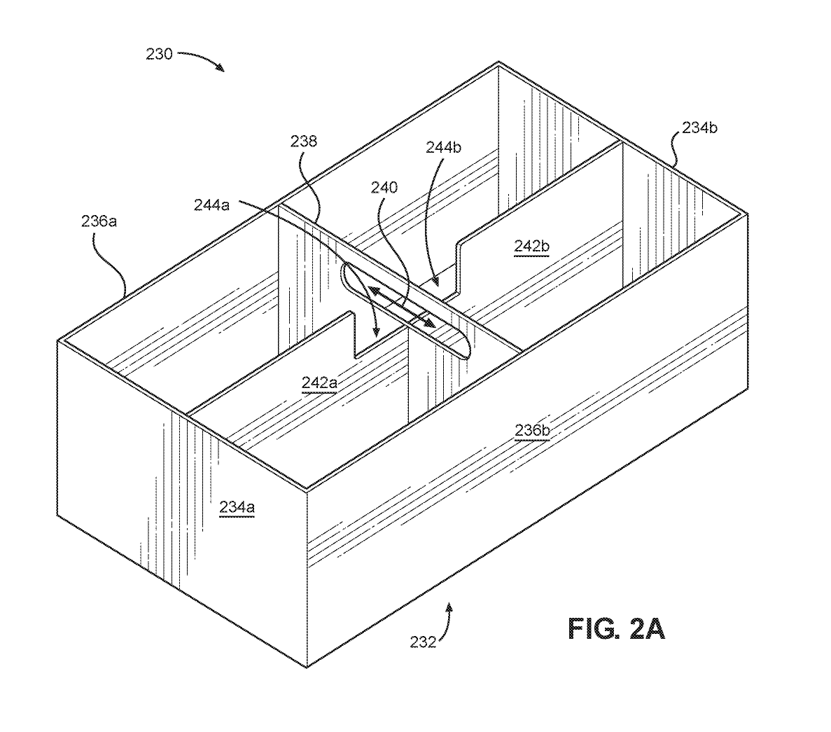

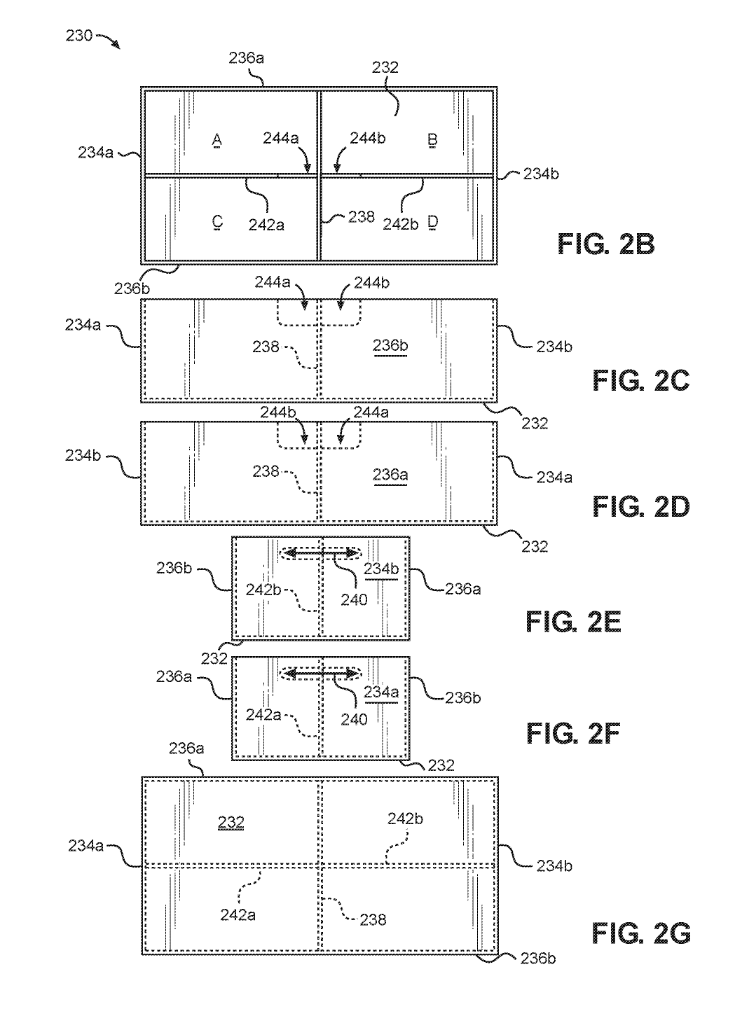

Referring to FIG. 2A, FIG. 2B, FIG. 2C, FIG. 2D, FIG. 2E, FIG. 2F, and FIG. 2G, perspective, top, left, right, front, back, and bottom views of a consumer product organization and packing system 230 according to some embodiments is shown. In some embodiments, the consumer product organization and packing system 230 may comprise a manufactured insert, tote organizer, or caddy having a bottom 232, two (2) opposing short sides 234a-b extending or protruding from the bottom 232 in a first direction and two (2) opposing long sides 236a-b extending or protruding from the bottom 232 in the first direction, e.g., generally forming a box-shape. According to some embodiments, the consumer product organization and packing system 230 may comprise a short divider 238 disposed between the two (2) opposing long sides 236a-b and extending or protruding from the bottom 232 in the first direction. In some embodiments, the short divider 238 may comprise and/or define an integral handle 240, such as by including a cutout portion operable to accept an insertion of a hand or grip, as depicted. According to some embodiments, the consumer product organization and packing system 230 may comprise one or more long dividers 242a-b disposed between the two (2) opposing short sides 234a-b and/or between one or more of the short sides 234a-b and the short divider 238, and extending or protruding from the bottom 232 in the first direction. In some embodiments, a first one of the long dividers 242a may be disposed between a first one of the short sides 234a and the short divider 238 and a second one of the long dividers 242b may be disposed between a second one of the short sides 234b and the short divider 238, as depicted.

In such a manner, for example, four (4) interior compartments or product storage areas “A”, “B”, “C”, and “D” may be formed or defined. In some embodiments, the storage areas may be of generally equal width, length, and depth, as depicted. The short divider 238 may be disposed and/or extend from or between the midpoints of the two (2) opposing long sides 236a-b, for example, the first one of the long dividers 242a may be disposed and/or extend from or between the midpoint of the first one of the short sides 234a and the midpoint of the short divider 238, and/or the second one of the long dividers 242b may be disposed and/or extend from or between the midpoint of the second one of the short sides 234b and the midpoint of the short divider 238. According to some embodiments, such as in the case that the two (2) opposing long sides 236a-b have a length that is greater than the two (2) opposing short sides 234a-b, the shape of the consumer product organization and packing system 230 may be generally rectangular and the shapes of the storage areas may accordingly be generally rectangular. In some embodiments, while the two (2) opposing long sides 236a-b are described as being “long” and the two (2) opposing short sides 234a-b are described as being “short”, all sides 234a-b, 236a-b may be equal in length—e.g., defining a generally square geometry for the consumer product organization and packing system 230 and the attendant storage areas.

According to some embodiments, the consumer product organization and packing system 230 and/or one or more of the long dividers 242a-b may comprise a cutout 244a-b. To facilitate a human grip of the integral handle 240, for example, the cutouts 244a-b may comprise portions of the long dividers 242a-b that are removed to permit clearance of a gripping object (not shown) engaged with or through the integral handle 240 (e.g., a human hand). In some embodiments, the cutouts 244a-b may be provided to allow the integral handle 240 to be flush with the top of the short divider 238 and/or the consumer product organization and packing system 230. As depicted, the integral handle 240 may be disposed underneath an upper portion of the consumer product organization and packing system 230 and/or the short divider 238 such that the integral handle 240 does not interfere with a lid (not shown) placed over the top of the storage areas and/or as a cover to the consumer product organization and packing system 230. A recessed integral handle 240 may also facilitate stacking of multiple consumer product organization and packing systems 230.

In some embodiments, the consumer product organization and packing system 230 may comprise an injection-molded plastic tote constructed of a plastic material having a suitable thickness and abrasion resistance to allow for extended re-use and re-usability, such as corrugated cardboard, suitably thick paperboard, and/or plastic-coated corrugated cardboard. The consumer product organization and packing system 230 may be constructed of various other suitable materials to allow for longevity and/or durability. According to some embodiments, the consumer product organization and packing system 230 may be provided in one or more colors. Different colored consumer product organization and packing systems 230 may be employed, for example, for different warehouse and/or retail store uses, such as for different types of products. In some embodiments, a first color of consumer product organization and packing system 230 may be utilized for small consumer products, while a second color consumer product organization and packing system 230 may be utilized for medium consumer products. Similarly, different colored consumer product organization and packing systems 230 may be utilized to indicate different number of storage compartments, to speed identification of a desired consumer product organization and packing system 230 configuration.

While two (2) the long dividers 242a-b and a single short divider 238 are shown, fewer or more dividers defining a desired number, shape, and/or size of storage compartments may be provided in some embodiments. According to some embodiments, different sets of consumer product organization and packing systems 230 with different numbers and/or configurations of storage compartments may be provided to a warehouse for enhanced organization of restock product units. In some embodiments, multiple consumer product organization and packing systems 230 may be utilized to increase in-store or in-warehouse transportability and/or to provide increased organizational possibilities.

According to some embodiments, any or all of the components 232, 234a-b, 236a-b, 238, 240, 242a-b, 244a-b of the consumer product organization and packing system 230 may be similar in configuration and/or functionality to any similarly named and/or numbered components described herein. Fewer or more components 232, 234a-b, 236a-b, 238, 240, 242a-b, 244a-b and/or various configurations of the components 232, 234a-b, 236a-b, 238, 240, 242a-b, 244a-b may be included in the consumer product organization and packing system 230 without deviating from the scope of embodiments described herein.

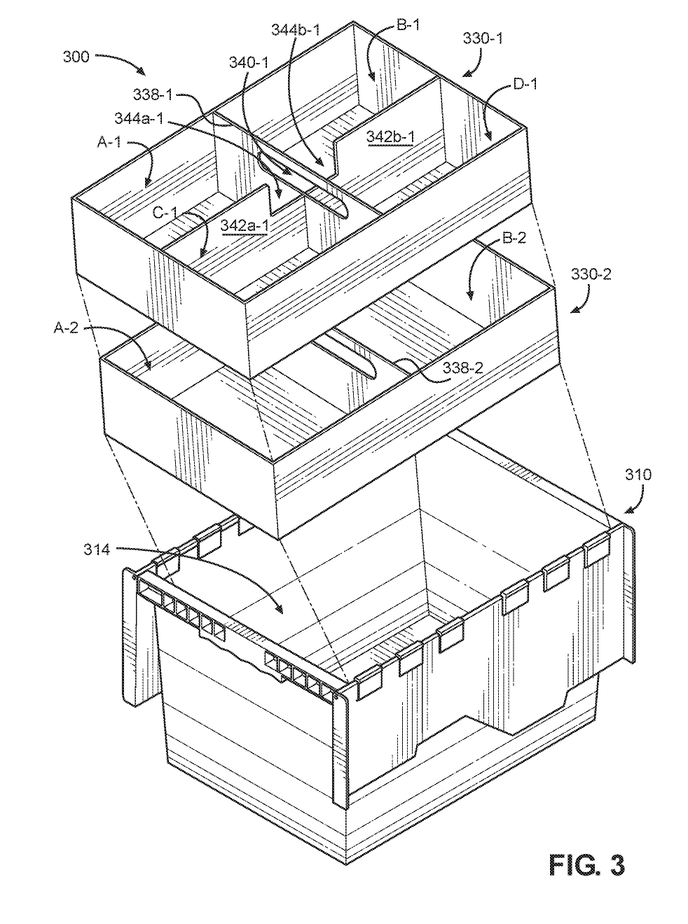

Turning to FIG. 3, for example, an assembly diagram of a consumer product organization and packing system 300 according to some embodiments is shown. In some embodiments, the consumer product organization and packing system 300 may comprise a master bin or tote 310 defining an interior storage volume 314. Instead of consumer products (such as small and/or medium consumer products) being tossed randomly and/or directly into the interior volume 314 as is standard practice, however, in some embodiments the consumer product organization and packing system 300 may comprise one or more organizer totes 330-1, 330-2 disposed within the interior volume 314. According to some embodiments, the organizer totes 330-1, 330-2 may comprise rigid plastic inserts sized and/or configured to fit within the interior volume 314. The organizer totes 330-1, 330-2 may, for example, be stacked and stored in a warehouse and inserted into the interior volume 314 of the master tote 310 by a warehouse employee prior to visiting “pick” locations to load ordered items into the master tote 310.

In some embodiments, a first one of the organizer totes 330-1 may define a box shape defining one or more interior compartments “A-1”, “B-1”, “C-1”, and/or “D-1”. As depicted, for example, the first one of the organizer totes 330-1 may comprise a first interior divider 338-1 that divides and/or bisects the interior of the first one of the organizer totes 330-1 (e.g., defining a first and second side of the interior of the first one of the organizer totes 330-1) and/or that defines or comprises a recessed and/or integral handle 340-1. In some embodiments, a second divider 342a-1 that divides and/or bisects the first side of the interior of the first one of the organizer totes 330-1, and/or a third divider 342b-1 that divides and/or bisects the second side of the interior of the first one of the organizer totes 330-1. In such a manner, for example, the interior of the first one of the organizer totes 330-1 may be divided and/or segmented into four (4) interior compartments “A-1”, “B-1”, “C-1”, and/or “D-1”, as shown. Fewer or more interior compartments may be provided as desired and/or based upon the types, sizes, shapes, and/or weights of products to be stored in the master tote 310. A second one of the organizer totes 330-2 may, for example, comprise a single divider 338-2 that divides and/or bisects the interior of the second one of the organizer totes 330-2 into two (2) interior compartments “A-2” and “B-2”.

According to some embodiments, the organizer totes 330-1, 330-2 may be configured to be stacked within the interior volume 314 of the master tote 310 while retaining the ability to be easily transported separately from the master tote 310 by a warehouse and/or retail store employee. The first one of the organizer totes 330-1 may comprise the recessed and/or integral handle 340-1, for example, and/or a plurality of divider cutouts 344a-1, 344b-1 that enable clearance for gripping of the handle 340-1. Each of the second divider 342a-1 and the third divider 342b-1 may, in some embodiments, respectively comprise a first divider cutout 344a-1 and a second divider cutout 344b-1. While the term “cutout” is utilized for ease of description and reference, the divider cutouts 344a-1, 344b-1 may comprise areas or portions of the second and third dividers 342a-1, 342b-1 that are formed to provide clearance to the handle 340-1. Instead of being formed as rectangular-shaped dividers, for example, the second and third dividers 342a-1, 342b-1 may be substantially rectangular except for the divider cutouts 344a-1, 344b-1 adjacent to the handle 340-1. In such a manner, for example, the handle 340-1 may be recessed within the interior of the first one of the organizer totes 330-1 such that it will not interfere with a closing or sealing of the master tote 310 when inserted therein. Similarly, in the case that the single divider 338-2 of the second one of the organizer totes 330-2 comprises an integral and recessed handle (not shown), such handle would not interfere with a stacking of the first one of the organizer totes 330-1 on top of the second one of the organizer totes 330-2 (e.g., within the interior volume 314 of the master tote 310).

In some embodiments, the organizer totes 330-1, 330-2 may comprise rigid inserts that may be easily nested within the master tote 310 and/or utilized separately, e.g., via the integral handle 340-1. The handle 340-1 may be centered geometrically in the first one of the organizer totes 330-1 to provide proper weight balance for carrying of the first one of the organizer totes 330-1 separate from the master tote 310 and/or for ease of insertion and/or removal of the first one of the organizer totes 330-1 from the master tote 310. According to some embodiments, such as in the case that non-symmetric interior compartments are provided by the first one of the organizer totes 330-1, the handle 340-1 may be offset geometrically to account for larger (e.g., medium) products being stored in larger compartments and smaller (e.g., small) products being stored in smaller compartments. In some embodiments, the features of the organizer totes 330-1, 330-2 may be rigid and/or fixed—e.g., in the case that the organizer totes 330-1, 330-2 are manufactured via injection-molded plastic techniques, extrusion, or other single-object creation technologies (e.g., 3-D printing). In some embodiments, some features may be foldable and/or removable. While the dividers 338-1, 338-2, 342a-1, 342b-1 may be rigidly-formed, for example, they may be removably and/or hingedly coupled to their respective organizer totes 330-1, 330-2 to allow the organizer totes 330-1, 330-2 to be reconfigured and/or folded flat.

According to some embodiments, any or all of the components 310, 314, 330-1, 330-2, 338-1, 338-2, 340-1, 342a-1, 342b-1, 344a-1, 344b-1 of the consumer product organization and packing system 300 may be similar in configuration and/or functionality to any similarly named and/or numbered components described herein. Fewer or more components 310, 314, 330-1, 330-2, 338-1, 338-2, 340-1, 342a-1, 342b-1, 344a-1, 344b-1 and/or various configurations of the components 310, 314, 330-1, 330-2, 338-1, 338-2, 340-1, 342a-1, 342b-1, 344a-1, 344b-1 may be included in the consumer product organization and packing system 300 without deviating from the scope of embodiments described herein.

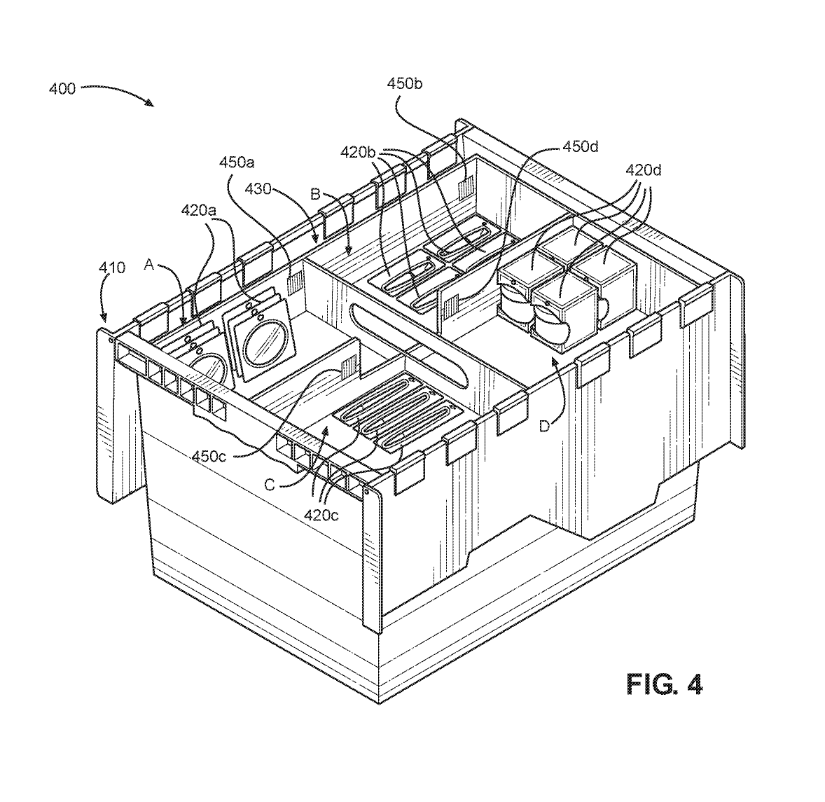

Referring now to FIG. 4, a perspective diagram of a consumer product organization and packing system 400 according to some embodiments is shown. The consumer product organization and packing system 400 may comprise, for example, a shipping bin or master tote 410 within which an organizational tote 430 is disposed. In some embodiments, the organizational tote 430 may comprise and/or define a plurality of product compartments “A”, “B”, “C”, and/or “D”, as depicted. In the case of retails store restocking orders sent to a warehouse facility, for example, a warehouse employee may place the organizational tote 430 within the master tote 410 and transport the system 400 through a warehouse (not shown) to various appropriate “pick” locations. At a first location, the warehouse employee may pick a first product 420a and load units of the first product 420a into a first product compartment “A” of the organizational tote 430. At a second location, the warehouse employee may pick a second product 420b and load units of the second product 420b into a second product compartment “B” of the organizational tote 430. At a third location, the warehouse employee may pick a third product 420c and load units of the third product 420c into a third product compartment “C” of the organizational tote 430. At a fourth location, the warehouse employee may pick a fourth product 420d and load units of the fourth product 420d into a fourth product compartment “D” of the organizational tote 430. In such a manner, for example, the warehouse employee may populate units of products 420a-d into the organizational tote 430 arranged, grouped, and/or pre-sorted by manufacturer, brand, weight, size, sub-category (e.g., a particular type of makeup), etc., prior to the system 400 being shipped to a retail store location. In some embodiments, once the organizational tote 430 is loaded with pre-sorted and/or arranged products 420a-d the master tote 410 may be closed and shipped to the retail store location.

At the retail store location, the master tote 410 may be received in a product loading and/or storage area (e.g., a back room) as is typical to the retail store's operations. In some embodiments, the master tote 410 may be carted onto the retail floor for restocking, as is also typical practice. Once opened, however, the presence of the organizational tote 430 within the master tote 410 allows for increased efficiency of restocking, as the products 420a-d are pre-sorted by brand, size, SKU, UPC, type, price, retail location identifier, etc. This pre-sorting allows the retail store employee to more directly, efficiently, and quickly transport products 420a-d to appropriate restock location on the retail sales floor. Time and motion studies have shown, for example, that use of the organizational tote 430 can reduce restocking time in the retail store location by approximately sixty percent (60%), which reduces lost profits by reducing retail store labor expenses. Less time spent on the retail floor also translates into less retail sales disruption (e.g., less time blocking aisles with the master tote 410), which increase sales and/or profits. Similarly, increasing the efficiency of restocking results in less out-of-stock time for products 420a-d (e.g., decreases product replenishment cycles), which also provides for decreased retail sales disruption. According to some embodiments, the organizational tote 430 may be carried directly onto the retail floor by being removed from the master tote 410. In-store transport of the organizational tote 430 without the master tote 410 needing to be moved may further save time and operational costs and/or may provide less disruption to the retail sales floor (e.g., the organizational tote 430 is smaller and less likely to block retails tore aisles when utilized separately).

According to some embodiments, the consumer product organization and packing system 400 may comprise one or more sensors 450a-d. The sensors 450a-d may comprise, for example, one or more active and/or passive RFID tags or devices, one or more Bluetooth® or other short-range communication beacons, and/or one or more other tracking, sensing, and/or informational storage devices. Each product compartment “A”, “B”, “C”, and “D” may, for example, comprise a dedicated sensor 450a-d such as an RFID tag that stores information descriptive of the particular product 420a-d stored in each respective compartment “A”, “B”, “C”, and “D”. In the warehouse, for example, the warehouse employee may utilize a handheld RFID device (not shown) that causes a first sensor 450a to store information descriptive of and/or identifying the first product 420a stored in the first compartment “A” of the organizational tote 430. This information may be utilized by a retail store employee to such as to verify the contents of the first compartment “A” and/or to receive in-store directions to the appropriate retail floor location at which the first product 420a should be stocked. The retail store employee may utilize a handheld device (not shown), for example, to interface with the sensors 450a-d to identify sales floor stock locations for reach of the products 420a-d and/or to receive an automatically generated in-store map or directions to each of the respective locations. According to some embodiments, fewer sensors 450a-d may be utilized, such as only a single first sensor 450a for the entire consumer product organization and packing system 400 and/or per organizational tote 430. Such a single sensor 450a may store all information relative to the organizational tote 430, such as a description and/or inventory of products 420a-d stored in each of the product compartments “A”, “B”, “C”, and “D”. According to some embodiments, the sensors 450a-d (whether employed as multiples or as the single sensor 450a) may provide tracking capabilities. The sensors 450a-d may be “active” by comprising power supplies and/or wireless communication devices (not separately shown), for example, such that the sensors 450a-d may report location information to one or more remotely situated devices, such as to locate lost master totes 410 and/or organizational totes 430. According to some embodiments, the sensors 450a-d may be operable to interact with RFID tags and/or barcodes on individual products 420a-d such that the sensors 450a-d may automatically sense and record product information for each organizational tote 430 and/or each respective compartment “A”, “B”, “C”, and “D” thereof, may increment or decrement a stored inventory value as products 420a-d are added or removed from the respective compartments “A”, “B”, “C”, and “D”, and/or may sound or trigger an alarm in the case a product 420a-d is removed from the respective compartments “A”, “B”, “C”, and “D” in contravention of one or more stored rules (e.g., products 420a-d should not be removed when not located in the warehouse or in a particular retail store, or room thereof—e.g., in proximity to a pre-installed signal generation device; or products 420a-d should not be removed before a certain elapsed time—e.g., in the case that the elapsed time is based upon a known or estimated shipping time, such as to prevent, alert, and/or dissuade removal of products 420a-d during transit/shipping).

In some embodiments, any or all of the components 410, 430, 420a-d, 450a-d of the consumer product organization and packing system 400 may be similar in configuration and/or functionality to any similarly named and/or numbered components described herein. Fewer or more components 410, 430, 420a-d, 450a-d and/or various configurations of the components 410, 430, 420a-d, 450a-d may be included in the consumer product organization and packing system 400 without deviating from the scope of embodiments described herein.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicant reserves the right to file additional applications to pursue patents for subject matter that has been disclosed and enabled, but not claimed in the present application.

What is claimed is:

1. A consumer product organization and packing system formed of rigid plastic, comprising:
a bottom;
four sides emanating from the bottom in a first direction, thereby defining an interior volume;
a first divider emanating from the bottom in the first direction and transecting the interior volume in a second direction, thereby defining two sections of the interior volume, the first divider comprising an integral handle recessed below a plane defined by the extents of the four sides in the first direction;
a second divider emanating from the bottom in the first direction and transecting a first one of the two sections of the interior volume in a third direction, thereby defining two compartments in the first one of the two sections, and the second divider comprising a cutout portion adjacent to the integral handle of the first divider; and
a third divider emanating from the bottom in the first direction and transecting a second one of the two sections of the interior volume in the third direction, thereby defining two compartments in the second one of the two sections, and the third divider comprising a cutout portion adjacent to the integral handle of the first divider.

2. The consumer product organization and packing system of claim 1, further comprising:
an RFID device coupled to interior surfaces of each of: (i) the two compartments in the first one of the two sections and (ii) the two compartments in the second one of the two sections.

3. The consumer product organization and packing system of claim 1, wherein the RFID devices store information identifying products stored in each of the respective compartments of the consumer product organization and packing system.
